(19) United States
(12) Patent Application Publication
(10) Pub. No.: US 2011/0169890 A1
(43) Pub. Date: Jul. 14, 2011

(54) LIQUID EJECTING APPARATUS

(75) Inventor: Keiji Hara, Minowa-machi (JP)

(73) Assignee: SEIKO EPSON CORPORATION, Shinjuku-ku (JP)

(21) Appl. No.: 12/987,935

(22) Filed: Jan. 10, 2011

(30) Foreign Application Priority Data
Jan. 12, 2010 (JP) 2010-003686

(51) Int. Cl. B41J 2/165

(52) U.S. Cl. 347/30

(57) ABSTRACT

When a negative pressure is introduced into a closed space formed by a cap abutting to an ejecting head, the cap abuts to the ejecting head with a greater pressing force than that in a case where the negative pressure is not introduced into the closed space. Therefore, the cap can abut to the ejecting head with a weak pressing force during the time when the negative pressure is not introduced, it can be avoided that the cap abuts to the ejecting head with a significant pressing force over a long time, and collapse of the cap can be significantly suppressed.

### BACKGROUND

1. Technical Field

The present invention relates to a liquid ejecting apparatus for ejecting a liquid from a liquid ejecting head.

2. Related Art

Generally, an ink jet printer provides a high quality image printing by ejecting a correct quantity of ink out of a fine ejecting nozzle to a correct position. Further, by using the ejecting technology, electrodes, sensors and bio-chips, and the like can be manufactured by ejecting various liquids instead of the ink to a substrate.

In the ejection technology, during the time when the liquid is not ejected, deterioration of the quality of the liquid through evaporation or volatilization of its components can be suppressed through capping the ejecting nozzle. However, when the quality of the liquid is deteriorated, the deteriorated liquid is suctioned from the ejecting nozzle through operating a suction pump that is connected to a cap, which is in a state where the ejecting nozzle is covered by the cap.

Also, when the ejecting nozzle is covered with the cap, the cap is pressed with a sufficient force to a surface (nozzle surface) to which the ejecting nozzle is installed so that a negative pressure does not leak even though the suction pump is operated. Further, there is described that discloses an ejecting apparatus in which two rigid caps having different stiffnesses are provided, the cap having low stiffness is used only when covering the ejecting nozzle, and the other cap having high stiffness is used when suctioning the liquid, in order to prevent the leakage of the negative pressure and the collapse of a seal (a portion to which the nozzle surface abuts) of the cap due to the negative pressure generated when suctioning the liquid (Refer to JP-A-2007-290264).

However, in the above described related art, because the cap is pressed to the nozzle surface with strong force to prevent the leakage of the negative pressure, the cap is collapsed, and thus the negative pressure is likely to leak.

### SUMMARY

An advantage of some aspects of this invention is that a liquid ejecting apparatus that can suppress the collapsing of the cap due to the pressing force of the cap against the nozzle surface is provided.

According to an aspect of the invention, there is provided a liquid ejecting apparatus by using a liquid head provided with a liquid ejecting nozzle, the liquid ejecting apparatus including: a capping portion that forms a closed space around the ejecting nozzle by abutting to the ejecting head; a capping portion-abutting unit that causes the capping portion to abut to the ejecting head; and a negative pressure-introducing unit that introduces a negative pressure into the closed space in a state where the capping portion abuts to the ejecting head, wherein, in a case where the negative pressure is introduced into the closed space, the capping portion-abutting unit causes the capping portion to abut to the ejecting head with a greater pressing force than that in a case where the negative pressure is not introduced therein.

In the liquid ejecting apparatus described above, by abutting the capping portion to the ejecting head and forming the closed space around the ejecting nozzle during the time when the liquid is not ejected, and deterioration of the quality of the liquid within the ejecting head is suppressed. Also, in a case that the quality of liquid within the ejecting head is deteriorated, the negative pressure is introduced to the closed space that is formed around the ejecting nozzle so as to suck out the deteriorated liquid from the ejecting nozzle. Further, in a case where the negative pressure is introduced into the closed space, the capping portion can abut to the ejecting head with a greater pressing force than that in a case where the negative pressure is not introduced therein.

Therefore, when the negative pressure is not introduced, since the pressing force of the capping portion with respect to the ejecting head can be made smaller, a “collapse” of the cap can be suppressed. Also, when the negative pressure is introduced, the capping portion can abut with respect to the ejecting head with greater pressing force, thus the negative pressure which is introduced into the closed space does not leak. Further, while the capping portion abuts to the ejecting head, a time that the negative pressure is introduced into the closed space is relatively short, and almost all the remaining time, the capping portion is only made to abut solely to the ejection head. Accordingly, in the invention, if it is set that the capping portion abuts with a large pressing force only when the negative pressure is introduced, the capping portion abuts to the ejecting head with a small pressing force most of the time, and thus, a “collapse” of the capping portion can be significantly suppressed.

In the liquid ejecting apparatus according to the aspect of the invention, the capping portion may include: a cap, an elastic member that applies a pressing force against the ejecting head to the cap when the cap abuts to the ejecting head, and a cap holder that supports the cap through the elastic member. The positional relationship between the cap and the cap holder in a state where the cap abuts to the ejecting head may be varied while causing the cap to abut to the ejecting head by driving the cap holder, and the capping portion-abutting unit may change the pressing force against the ejecting head.

Therefore, due to the cap being pressed to the ejecting head by the elastic member, the cap can abut to the ejecting head by a stable pressing force. Also, by means of a variation amount of the elastic member varied by the positional relationship between the cap and the cap holder in a state where the cap abuts to the ejecting head, the pressing force against the ejecting head can be varied.

Further, in the liquid ejecting apparatus, the negative pressure-introducing unit may include a negative pressure pump, a negative pressure path that introduces the negative pressure generated by the negative pressure pump into the closed space, and an opening/closing portion that opens and closes the negative pressure path. Also, the opening/closing portion of the negative pressure path may be opened in conjunction with an operation making the pressing force, which causes the ejecting head abut to the cap, largely by varying a relationship between the cap and the cap holder.

Therefore, since the negative pressure path opening in conjunction with the operation making the pressing force of the cap increases, simply by performing an operation for changing the pressing force, and the opened and closed states of the opening/closing portion can be changed appropriately. Thus, for example, though a plurality of caps is installed, a control in which the negative pressure is introduced into only the cap that is pressed by a high pressing force in a state where the negative pressure is not introduced with respect to the cap that is pressed by a small pressing force can be achieved simply.

### BRIEF DESCRIPTION OF THE DRAWINGS

The invention will be described with reference to the accompanying drawings, wherein like numbers reference like elements.

FIG. 1 is an explanatory view of schematic construction of the embodiment of using an ink jet printer as one example.

FIG. 2A and FIG. 2B are explanatory views of a schematic construction of a lifting unit installed in a maintenance mechanism of the embodiment.

FIGS. 3A to 3C are explanatory views illustrating the operational aspect of the maintenance mechanism of the embodiment performing the maintenance of an ejecting head.

FIG. 4 is an explanatory view illustrating a schematic construction of the maintenance mechanism of a first modification.

FIGS. 5A to 5C are explanatory views illustrating the operational aspect of the maintenance mechanism of the first modification performing the maintenance of the ejecting head.

FIGS. 6A to 6C are a perspective views illustrating a construction of a maintenance mechanism of a second modification.

FIGS. 7A to 7D are explanatory views illustrating the operational aspect of the maintenance mechanism of the second modification performing the maintenance of an ejecting head.

FIG. 8 is an explanatory view illustrating a lifting unit of a third modification.

FIGS. 9A to 9D are explanatory views illustrating an operation of the lifting unit of the third modification.

FIG. 10 is an explanatory view illustrating a fourth modification applied a lifting unit to a line printer.

FIGS. 11A to 11C are explanatory views illustrating shapes of cams mounted to the lifting unit of the fourth modification.

FIG. 12 is an explanatory view illustrating variations of a lift amount of the cam when the lifting unit of the fourth modification is operated.

### DESCRIPTION OF EXEMPLARY EMBODIMENTS

Hereinafter, exemplary embodiments are described according to the following order so as to clarify contents of this invention.

### A. Construction of a Liquid Ejecting Apparatus

### B. Lifting Unit of an Embodiment

### C. Modifications

### C-1. First Modification

### C-2. Second Modification

### C-3. Third Modification

### C-4. Fourth Modification

### A. Construction of the Liquid Ejecting Apparatus

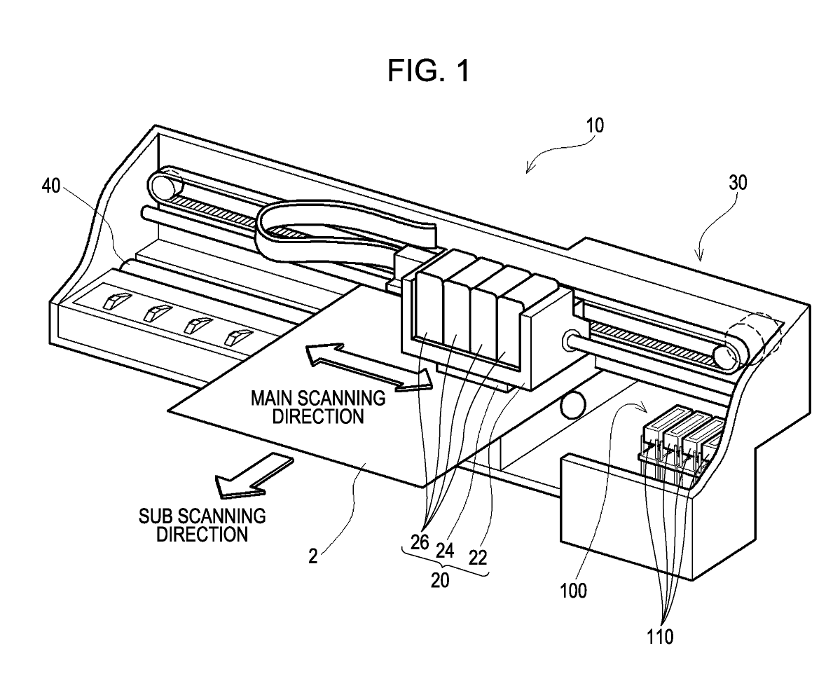

FIG. 1 is an explanatory view of the schematic construction of a liquid ejecting apparatus of the embodiment using so-called ink jet printer as an example. As illustrated FIG. 1, the ink jet printer 10 includes: a carriage 20 that forms an ink dot on a printing medium 2 while reciprocating in a main scanning direction, a driving unit 30 that reciprocates the carriage 20, and a paper feed roller 40 that feeds the printing medium 2, and the like. Also, in non-printing area (sometimes called “home position”) positioned at the ends of an area in which the carriage 20 is driven along with the main-scanning, a maintenance mechanism 100 is disposed to maintain the printer in order to appropriately perform ejection of the ink.

The carriage 20 includes: an ink cartridge 26 that receives black ink, cyan ink, magenta ink, and yellow ink, respectively, and a carriage case 22 that mounts the ink cartridges 26, and the like. An ejecting head 24 for ejecting the ink droplets is disposed at a lower surface of the carriage case 22. A plurality of ejecting nozzles is disposed according to a color of ink in a lower surface of the ejecting head 24, and when the ink within the ink cartridge 26 is fed to the ejecting head 24, a correct quantity of ink is ejected from the ejecting nozzle to the printing medium 2. Further, the surface in which the plurality of ejecting nozzles for ejecting the ink is disposed at the lower surface side of the ejecting head 24 may be called a “nozzle surface”.

During the time when the ink is not ejected, the quality of ink is deteriorated because volatiles of ink are evaporated from the ejecting nozzle disposed at the nozzle surface of the ejecting head 24. Therefore, a cap 110 formed of rubber material is installed at the maintenance mechanism 100, when the ink is not ejected, the ejecting head 24 is moved up to the position of the maintenance mechanism 100. Thus, by performing a movement of abutting to the cap 110 to the nozzle surface, deterioration of the quality of ink can be suppressed. As described above, in this embodiment, corresponding to rows of nozzle which are disposed according to the color of the ink at the nozzle surface of the ejecting head 24, four caps 110 are installed at the maintenance mechanism 100.

As described hereinafter, the cap 110 installed at the maintenance mechanism 100 is connected to a suction pump via a suction tube. Even if the quality of the ink within the ejecting head 24 is deteriorated due to the printing not being performed for many hours, an operation for suctioning the deteriorated ink (cleaning operating) is performed by operating the suction pump in a state where the cap 110 abuts to the nozzle surface. Also, a feed roller 40 is driven by a driving motor or a gear mechanism (not shown) and the printing medium 2 is fed by the predetermined amount along a sub-scanning direction.

In this, the cap 110 installed in the maintenance mechanism 100 abuts to the ejecting head 24 during the capping operation or the cleaning operation, but, in normal times, the cap is retreated to a position where does not become interference in the ejecting head 24. According to this, a lifting unit for lifting the retreated cap 110 and abutting to the ejecting head 24 is installed in the maintenance mechanism 100.

As described above, the cap 110 is used not only to simply abut to the nozzle surface, but also to suction out the ink from the ejecting nozzle by driving the suction pump in the state where the cap abuts to the nozzle surface. Thus, the cap 110 is pressed to the nozzle surface with sufficient force so as not to leak the negative pressure even with the operation of the suction pump. However, the cap 110 may be collapsed due to operation over an extended period, thus, there is concern that the negative pressure is likely to be leaked. Therefore, the maintenance mechanism 100 of this embodiment installed in the ink jet printer 10 adopts the following described lifting unit so as to suppress and control the “collapse” of the cap 110 as possible.

B. Lifting Unit of this Embodiment

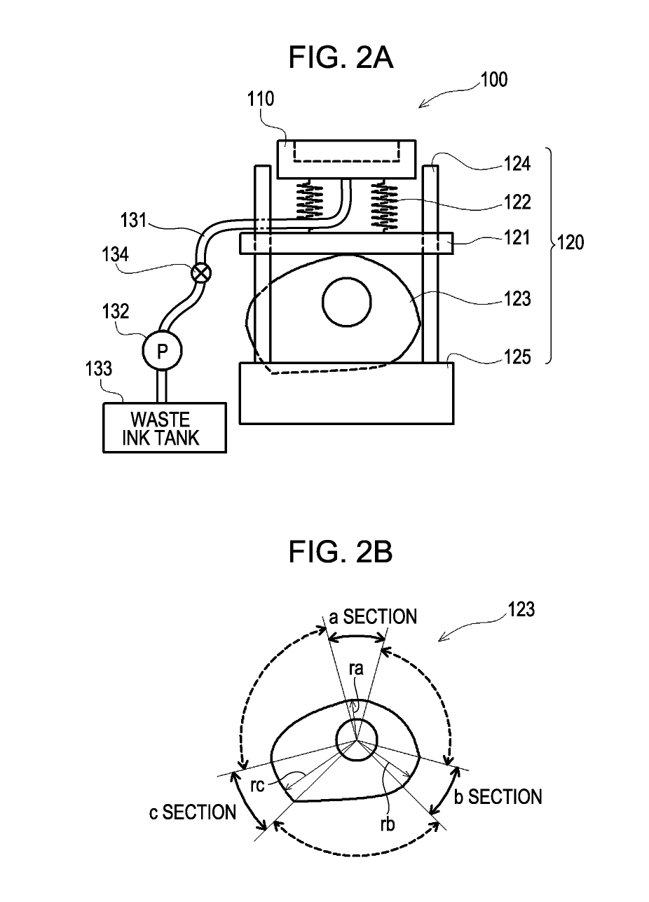

FIG. 2A and FIG. 2B are explanatory views of a schematic construction of a lifting unit 120 installed in a maintenance mechanism 100 of the embodiment. Also, in the maintenance mechanism 100 of the embodiment, as described above, the plurality of ejecting nozzles is installed to each the type of color of ink, and caps 110 are installed to each the plurality of ejecting nozzles (see FIG. 1). Therefore, though the lifting units 120 are installed to the caps 110 respectively, for clarity of the drawing and easy understanding of this embodiment, only one cap 110 and only lifting unit 120 for lifting the cap 110 are illustrated as representative in FIGS. 2A and 2B.

As illustrated in FIG. 2A, the lifting unit 120 includes: a substrate plate 121 that is installed below the cap 110, a spring 122 supporting from below the cap 110 that is installed on the substrate plate 121, a cam 123 that lifts and lowers the substrate plate 121, a guide pole 124 that guides the lifting and lowering of the substrate plate 121, and a base 125 that mounts the cam 123 or the guide pole 124. The guide pole 124 is erected to the upper surface side of the base 125, and is slidably penetrated through the substrate plate 121. Also, the cam 123 is fixed to a rotational shaft, and the substrate plate 121 can be slidably lifted and lowered while being guided by the guide pole 124 by means of the rotations of the shaft and the cam 123. As a result of this, it is possible that the cap 110 may be moved up and down in a state where the cap 110 is supported by the spring 122.

Also, the cap 110 is connected to a waste ink tank 133 via a suction tube 131 or the suction pump 132 suctioning the ink, an opening/closing valve 134 is installed between the cap 110 and the suction pump 132. Accordingly, the opening/closing valve 134 of the cap 110 that does not suction the ink is closed while the opening/closing valve 134 of the cap 110 suctioning the ink is opened, and in the above condition, if the suction pump 132 is operated, it is possible that the negative pressure may be fed to only the cap 110 of the opened opening/closing valve 134 and the suction of ink is performed.

FIG. 2B illustrates the shape of the cam 123 installed in the lifting unit 120. As illustrated in FIG. 2B, the cam 123 includes “a region” in which a radius from a center of the cam is set to “ra”, “b region” in which the radius from the center of the cam is set to “rb”, and “c region” in which the radius from the center of the cam is set to “rc”. Also, transition regions, in which the distances from the center of the cam are varied gradually, are disposed between the regions. Therefore, the cam 123 is rotated from the “a region” to “b region” in a state where the cam 123 abuts to the substrate plate 121, and the cam 123 can push the substrate plate 121 upwards. In addition, if the cam 123 is rotated to “c region”, the substrate plate 121 can be further pressed by the cam. As a result, the substrate plate 121 can be changed to 3 steps, that is, a lowest position, a medium position, a highest position, by rotating the cam 123.

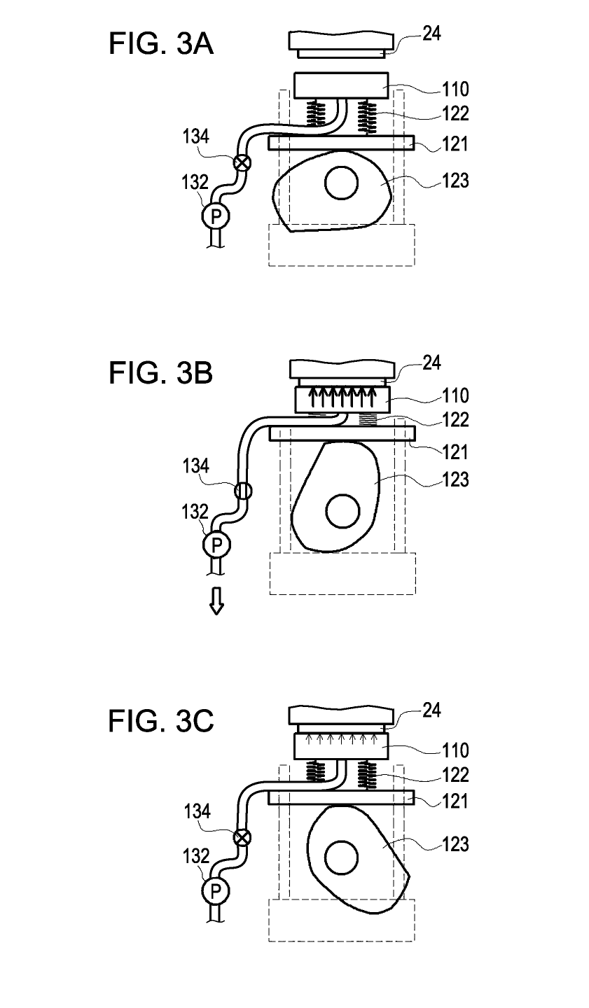

FIGS. 3A to 3C are explanatory views illustrating the operational aspect of the maintenance mechanism 100 for performing the maintenance operation of the ejecting head 24. As described above, when the capping operation or the cleaning operation is performed, the ejecting head 24 is moved up to the position (i.e., home position) of the maintenance mechanism 100. At this time, as illustrated in FIG. 3A, the cam 123 of the maintenance mechanism 100 abuts to the substrate plate 121 at the “a region” shown in FIG. 2B, and the height of the substrate plate 121 reaches the lowest position. Accordingly, the height of the cap 110 which is supported by the spring 122 disposed on the substrate plate 121 becomes lowest. In this situation, the ejecting head 24 and the cap 110 are not in contact with each other.

Then, when the cam 123 is rotated, the cam 123 is moved from “a region” to “c region” in position where the cam abuts to the substrate plate 121. Thereby, the substrate plate 121 can be further pressed by the cam 123; accordingly, the cap 110 disposed on the substrate plate 121 is lifted up. In the course of the operation, the cap 110 abuts to the nozzle surface of the ejecting head 24, and the substrate plate 121 is lifted continuously even thereafter, therefore, the spring 122 disposed between the cap 110 and the substrate plate 121 is compressed. Consequently, as described in FIG. 3B, the cam 123 abuts to the substrate plate 121 at the area of the “c region” and finally, the spring 122 is at its most compressed. Thus, the cap 110 is significantly pressed to the nozzle surface by a repulsive force of the spring 122, thus the negative pressure does not leaked even the suction pump 132 is operated. Therefore, it is possible to reliably suction out even the deteriorated and viscid ink.

When the suctioning operation (cleaning operation) is ended, the cam 123 is rotated after the opened opening/closing valve 134 is closed and the suction pump 132 is stopped, and the cam 123 is changed from the “c region” to “b region” in the state where the cam 123 abuts to the substrate plate 121. Thereby, in a state where the cap 110 abuts to the nozzle surface, the substrate plate 121 is lowered gradually and the compressive force of the spring 122 slowly decreases. As described in FIG. 3C, when the cam 123 abuts to the substrate plate 121 at the “b region”, the cap 110 is abutted to the nozzle surface in a state where the spring 122 is compressed with a small force. As a result, in a state where the cap 110 is pressed to the nozzle surface with a small force by the repulsive force of the spring 122, the operation for capping the nozzle surface (the capping operation) can be performed.

In the above described embodiment, the capping operation following the cleaning operation is described below, but the capping operation can be directly performed without performing the cleaning operation. In this case, as described in FIG. 3A, the cam 123 can be rotated in the state where the “a region” of the cam 123 abuts to the substrate plate 121, and the position where the substrate plate 121 and the cam 123 are in contact to each other is moved directly to “b region”.

If the nozzle surface is capped as described above, the ejecting head 24 is preserved with the condition as shown in FIG. 3C until the printing begins. Accordingly, deterioration of the quality of ink due to volatiles being evaporated from the ejecting nozzle of the ejecting head 24, and the like can be suppressed. Also, if the printing resumes from the above condition, the cam 123 is rotated, and the position of the cam abutting to the substrate plate 121 is moved from “b region” to “a region”. Thereby, the substrate plate 121 is lowered again, as shown in FIG. 3A, and the cap 110 is separated from the nozzle surface. As a result, the ejecting head 24 is moved from the home position to the printing area, and it is possible to resume the printing.

As described above, in the lifting unit 120 of the embodiment, the cap 110 can be pressed with a strong force to the nozzle surface during the cleaning operation while the cap 110 can be pressed to the nozzle surface during the capping operation with smaller force than the force of the cleaning operation. Thus, the pressing force of cap 110 can be changed, and the “collapse” of the cap 110 can be greatly suppressed. The reasons are as follows; first of all, the duration of the ink suction is relatively short, and the cap 110 abuts to the nozzle surface most of the time. Also, the cap 110 needs not to be sufficiently pressed to the nozzle surface if not performing the suction of ink. That is, if the cap 110 needs to be pressed with strong force only when performing the suction of ink, the cap 110 may be just maintained to press with weak force to the nozzle surface for most of the time. Therefore, the “collapse” of the cap 110 can be suppressed according to the above reasons. Also, if the cap 110 needs to be pressed with strong force to the nozzle surface only when performing the suction of ink, thus the collapse of the cap 110 is unlikely to occur, a sufficient air-tightness is preserved and the suctioning out of the ink can be performed correctly.

Similar to the maintenance unit 100 of the embodiment, the lifting unit 120 each to the cap 110 corresponding to the color of ink is installed respectively, thus, only the cap 110 for suctioning the ink is strongly pressed to the nozzle surface, and the cap 110 which does not suction the ink can be weakly pressed to the nozzle surface. Therefore, compared to a load of the cap 110 of ink performing the suction frequently, a load applied to the cap 110 of ink, which performs the suction occasionally, can be significantly reduced, and a “collapse” of the cap 110 can be further suppressed.

### C. Modification

In the described embodiment, some modifications can be considered. The modifications are briefly described below.

### C-1. First Modification:

In the described embodiment, by installing the opening/closing valve 134 between the cap 110 and the suction pump 132, the opening/closing operation is achieved between the state where the negative pressure is applied to the cap 110 and the state where the negative pressure is not applied to the cap. However, instead of installing the opening/closing valve 134, the opening/closing between the negative pressure operating state and the negative pressure non-operating state can be realized as below.

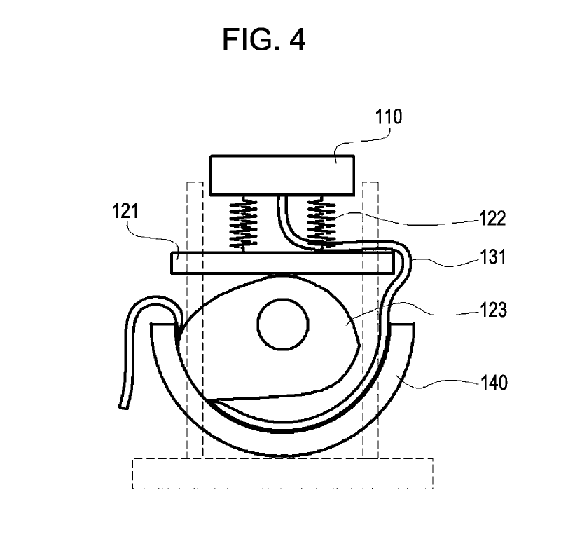

FIG. 4 is an explanatory view illustrating a schematic construction of the maintenance mechanism 100 of a first modification. As shown in FIG. 4, the maintenance mechanism 100 of the first modification is almost identical with the maintenance mechanism 100 of the above described embodiment, but the opening/closing valve 134 (see FIG. 2A) is not installed, instead of the opening/closing valve, a semi-cylindrical abutting member 140 is installed toward a lower portion of the cam 123. The abutting member 140 is disposed so that the “c region” of the cam 123 (see FIG. 2B) passes through while leaving a narrow space between an inner wall of the abutting member 140 and the cam when the cam 123 is rotated. Also, in the position that the cam 123 passes through the “c region”, the suction tube 131 is disposed at the inner wall portion of the abutting member 140 so that the suction tube 131 that is connected from the cap 110 to the suction pump 132 extends. Thus, the abutting member 140 is installed in the maintenance mechanism 100, as described above, and the connection state between the cap 110 and the suction pump 132 is switched appropriately while the cap 110 is pressed to the ejecting head 24 by the lifting unit 120. This matter will be described below in more detail.

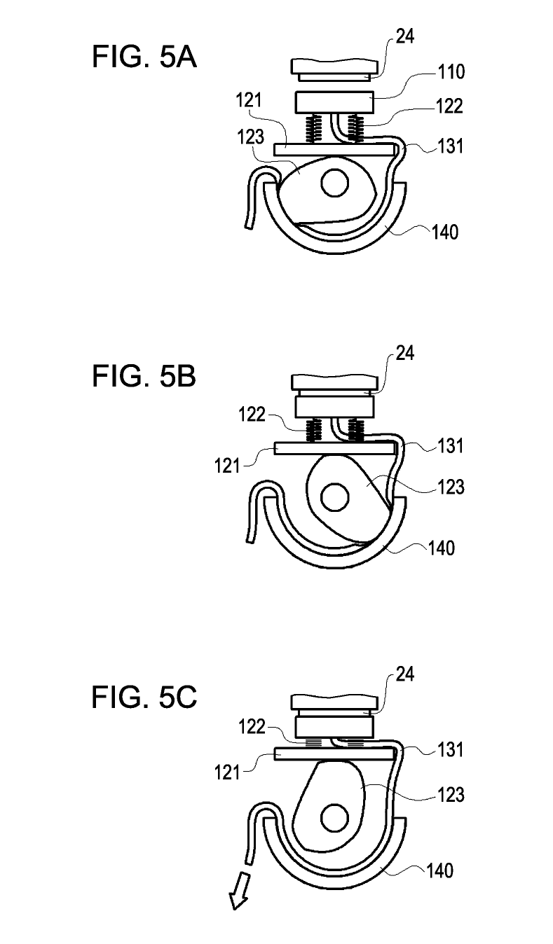

FIGS. 5A to 5C are explanatory views illustrating the operational aspect of the maintenance mechanism 100 of the first modification performing the maintenance of an ejecting head 24. FIG. 5A illustrates the state (hereinafter, called an “opened state”) where the cap 110 does not abut to the nozzle surface of the ejecting head 24, FIG. 5B illustrates the state (hereinafter, called a “storage state”) in which the cap 110 is pressed with a weak force to the nozzle surface. Also, FIG. 5C illustrates the state (hereinafter, called a “suctioning state”) in which the cap 110 is pressed with a strong force to the nozzle surface for suctioning the ink.

As shown in FIG. 5A which illustrates the opened state, the “c region” of the cam 123 is directed to the downward (i.e., the position on which the abutting member 140 is installed), the suction tube 131 is pressed by the “c region” of the cam 123 and the inner wall portion of the abutting member 140. Further, as shown in FIG. 5B which illustrates the storage state, the “c region” of the cam 123 is directed downward, thus the suction tube 131 is pressed. Thus, in a state where the suction tube 131 is pressed and the connection between the cap 110 and the suction pump 132 is interrupted, there is no operation action of the negative pressure in the ejecting nozzle even with operating the suction pump 132.

Meanwhile, as shown in FIG. 5C which illustrates the suctioning state, the “c region” of the cam 123 is directed to upward (i.e., a reverse direction against the direction on which the abutting member 140 is disposed. Thus, as shown in FIG. 5A or FIG. 5B, the suction tube 131 which is pressed by the “c region” of the cam 123 and the inner wall portion of abutting member 140, is opened, if the suction pump 132 is operated, thus the ejecting nozzle can be operated by the negative pressure. Also, as described above, the cap 110 is installed each to the color of ink in the maintenance mechanism 100 (see FIG. 1); thus, if only the cap 110 suctioning the ink is in the suction state (see FIG. 5C) and other caps 110 are the storage state (FIG. 5B), a desired ink can be selectively suctioned only by driving the suction pump 132. Therefore, for example, even though there are many kinds of ink, it is possible to simplify the control for selectively suctioning the ink.

Also, in the maintenance mechanism 100 of the first modification, it is described that the cam 123 directly performs the opening/closing operation of the suction tube 131, but it is not limited to the method. For example, using the mechanical movement (e.g. the lifting and lowering movement of the substrate plate 121) generated accompanying the rotation of the cam 123, opening and closing of suction tube 131 can be performed. As an example thereof, the following method can be considered. That is, a pressing mechanism, which can switch whether the suction tube 131 is pressed or not according to the positions of the substrate plate 121, is installed. Further, the pressing mechanism is structured so as to press the suction tube 131 if the substrate plate 121 is positioned at the lower portion (i.e., the opened state or the storage state) and to not press the suction tube 131 if the substrate plate 121 is positioned at the higher portion (i.e., suctioning position). Even in the above method of using the pressing mechanism, the opening/closing operation of the suction tube 131 can be appropriately performed according to the conditions of the maintenance mechanism 100.

### C-2. Second Modification:

In the maintenance mechanism 100 of the first modification, it is described that the abutting member 140 is installed and pressed to downwards of the cam 123, the suction tube 131 is pressed by the abutting member 140 and the cam 123, thus the opening/closing operation of the connection between the cap 110 and the suction pump 132 is achieved. Further, following components can be added to the maintenance mechanism 100; thus, an operation (atmosphere opening operation) by which outside air is introduced into the cap 110 can be realized.

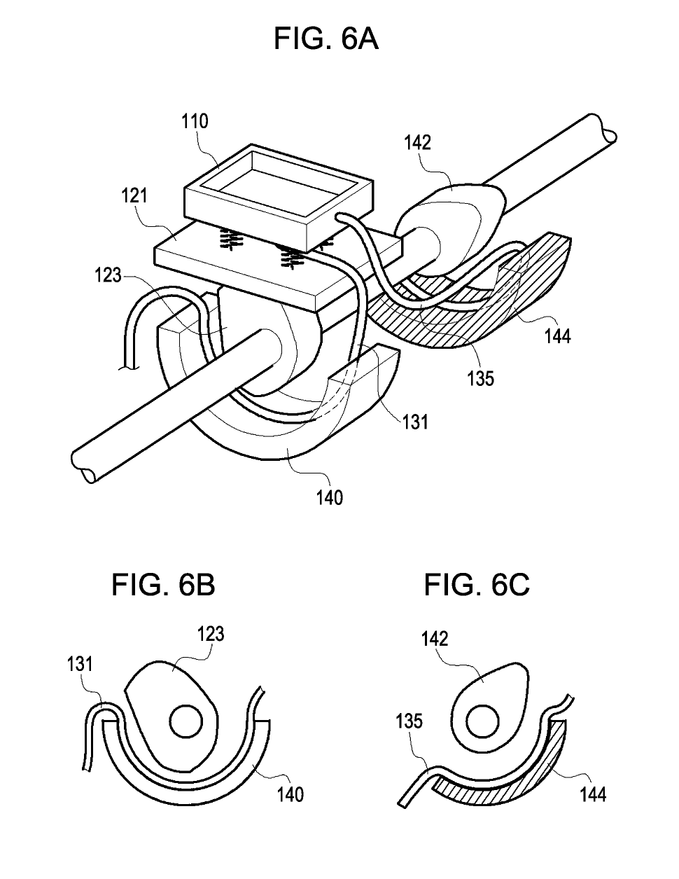

FIGS. 6A to 6C are a perspective views illustrating a construction of the maintenance mechanism 100 of the second modification. As shown in FIG. 6A, in the maintenance mechanism 100 of the second modification, a second cam 142 is installed at the inner side of a cam 123 (hereinafter, called a “first cam 123”), and the first cam 123 and the second cam 142 are fixed to a same shaft. Also, in the inner direction of an abutting member 140 (hereinafter, called a “first abutting member 140”), a second abutting member 144 is installed downwards of the second cam 142.

Also, FIG. 6B illustrates shapes of the first cam 123 and the first abutting member 140, and FIG. 6C illustrates shapes of the second cam 142 and the second abutting member 144. As shown in FIG. 6C, the second cam 142 is different to the first cam 123 illustrated in FIG. 6B, that is, as in a general cam-shape, only one portion of the second cam is protruded. Also, as shown in FIG. 6C, the second abutting member 144 which is installed downward of the second cam 142 is a semi-cylindrical shape approximately, however one end (the left end of the drawing) of the second abutting member 144 is shorter than that of the first abutting member 140 shown in FIG. 6B. The second abutting member 144 is disposed so that the protrusion of the second cam 142 passes through while leaving a narrow space between the protrusion and the inner wall portion of second abutting member 144 when the second cam 142 is rotated. Moreover, the atmosphere opening tube 135 which is led from the cap 110 is extended and disposed at which the protrusion of the second cam 142 passes through. Due to the second cam 142 and the second abutting member 144 being installed in the maintenance mechanism 100, as described below, the inner portion of the cap 110 can be opened to the atmosphere at an appropriate timing while performing the maintenance operation.

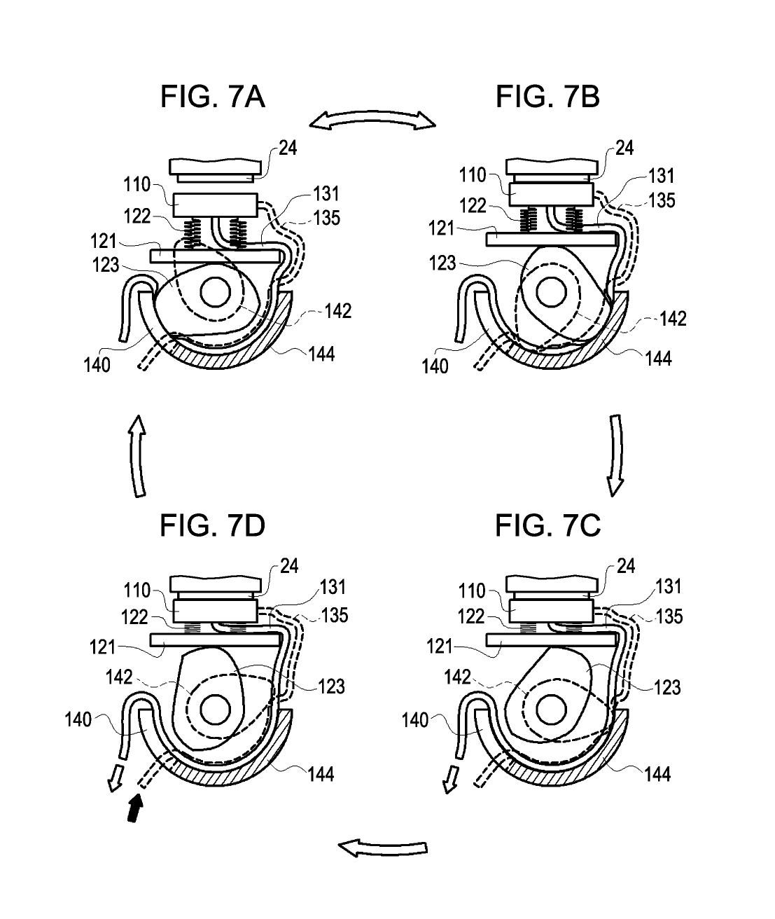

FIGS. 7A to 7D are explanatory views illustrating the operational aspect of the maintenance mechanism 100 of the second modification performing the maintenance of an ejecting head 24. FIG. 7A illustrates the opened state, FIG. 7B illustrates the storage state, and FIG. 7C illustrates the suctioning state. Also, FIG. 7D illustrates a state (an idle-suctioning state) in which the ink remaining in the cap 110 is discharged after suctioning the ink in the suctioning state in shown in FIG. 7C. In FIG. 7A to 7D, the first cam 123, the suction tubes 131, and the first abutting member 140, which are disposed at the front side of the maintenance mechanism 100, are indicated by a solid line. Also, the second cam 142, the atmosphere opening tube 135, and the second abutting member 144, which are disposed at the inner side of the maintenance mechanism 100, are indicated by a broken dashed line.

As shown in FIG. 7A, in the opened state of the maintenance mechanism 100, the suction tube 131 is pressed by the first cam 123 and the first abutting member. At this time, the protrusion of the second cam 142 is directed upward (i.e., the direction opposite to the second abutting member 144), the atmosphere opening tube 135 is not pressed by the second cam 142. From the above state, the first cam 123 is rotated and the maintenance mechanism 100 is changed to the storage state. As described above, due to the first cam 123 and the second cam 142 being fixed to the same shaft, the second cam 142 together with the first cam 123 are rotated. Thereby, as shown in FIG. 7B, along with the suction tube 131 being pressed by the first cam 123 and the first abutting member, the second cam 142 is directed downward (i.e., the direction of the second abutting member 144), and the atmosphere opening tube 135 is pressed by the second cam 142 and the second abutting member 144. Therefore, due to the atmosphere opening tube 135 being pressed at the storage state, the outside air is not introduced into the cap 110, thus, evaporation of volatiles of the ink from the ejecting nozzle can be suppressed.

Also, if the first cam 123 (and the second cam 142) are rotated and enter the storage state, as shown in FIG. 7C, the atmosphere opening tube 135 is still pressed by the second cam 142 while the suction tube 131 is the opened state. Accordingly, if the suction pump 132 is driven in the above state, the negative pressure does not leak, thus the ink is suctioned from the ejecting nozzle. Also, when suction of the ink is ended, the first cam 123 (and the second cam 142) is rotated a little in the state where the suction pump 132 is operated, as shown in FIG. 7D, and the protrusion of the second cam 142 is directed to upward. Therefore, the atmosphere opening tube 135 is also in the opened state, the idle-suction operation (an operation at which the ink within the cap 110 is suctioned along with introducing the outside air into the cap 110) can be performed. Also, while the ink within the cap 110 is discharged by the idle-suctioning, the driving of suction pump 132 is stopped, if the first cam 123 (and the second cam 142) is rotated, and the maintenance mechanism 100 can be returned to the opened state (the state of FIG. 7A) again.

As described above, in the maintenance mechanism 100 of the second modification, the suctioning state and the idle-suctioning state can be switched by changing the rotation position of the first cam 123 (and the second cam 142) slightly in the state where the suction pump 132 is driven. Thus, when performing the idle-suctioning of the ink, due to the opening and closing of the atmosphere opening tube 135 not needing to be performed separately, the control for the suction of ink can simplified.

Also, as described above, since the one end (the left end of FIG. 6B) of the second abutting member 144 installed in the maintenance mechanism 100 of the second modification being shorter (see FIG. 6B), the atmosphere opening tube 135 is not pressed by the second cam 142 in the position of the shorter end. Therefore, when changing from the storage state of FIG. 7B to the opened state of FIG. 7A, due to the atmosphere opening tube 135 being opened and the air within the cap 110 being open, the cap 110 is separated from the nozzle surface. Thus, when the cap 110 is ripped from the storing state, even if the negative pressure is generated, the cap 110 can be ripped upon release of the negative pressure.

### C-3. Third Modification

In the above described lifting units 120 of the embodiment, the first modification, and the second modification, the substrate plate 121 is lifted and the spring 122 is compressed after the cap 110 abuts to the nozzle surface of the ejecting head 24, thus, the pressing force of the cap 110 is increased. However, from adapting of a lifting unit described below, it is further possible that the pressing force is changed immediately after the cap 110 abuts to the nozzle surface.

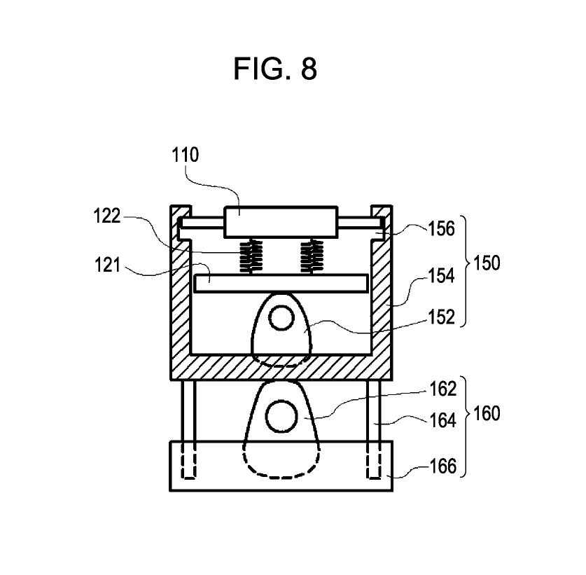

FIG. 8 is an explanatory view illustrating a lifting unit of the third modification. As shown in FIG. 8, the third modification of the lifting unit largely consists of an upper unit 150 and a lower unit 160. The upper unit 150 includes a first cam shaft 152 which can switch the position of the substrate plate 121 to two steps of a high step and a low step, the cap 110, the spring 122, the substrate plate 121, and a box-type member 154 for receiving the first cam shaft 152. An upper surface (i.e., the upward surface of the cap 110) of the box-type member 154 is opened, and a hook portion 156 is formed near the upper surface of the box-type member 154 so that a handle extended horizontally from the cap 110 is caught.

The lower unit 160 includes a second cam shaft 162 for lifting and lowering the box-type member 154 of the upper unit 150, a guide pole 164 for guiding the lifting and lowering of the box-type member 154, and a base 166 to which the second cam shaft 162 and the guide pole 164 are installed. The guide pole 164 is erected slidably in relation to the base 166, and the position of the box-type member 154 can be switched between two steps of a high step and low step by rotating the second cam shaft 162.

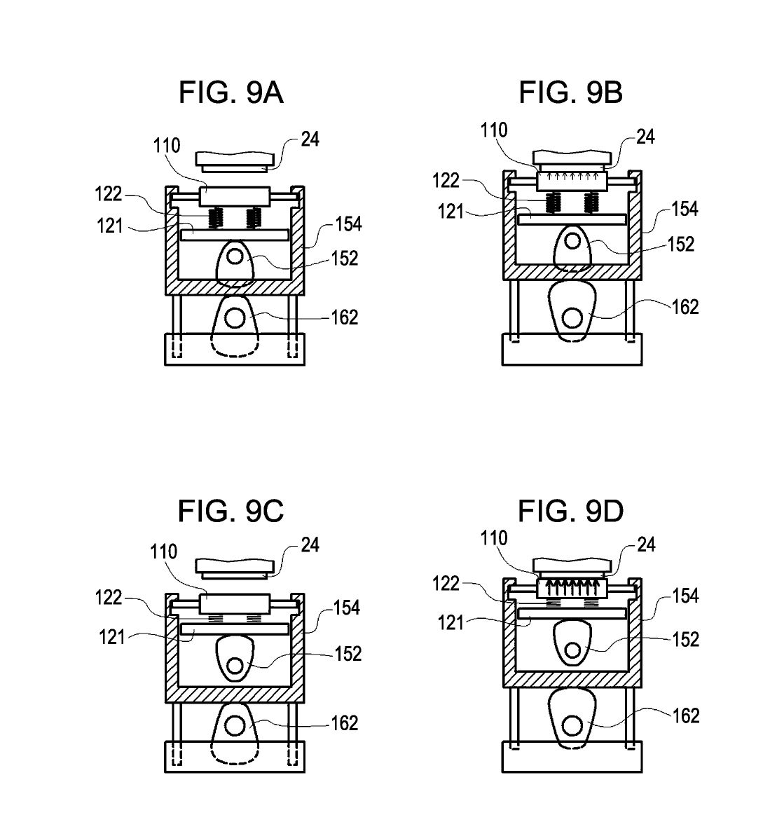

FIGS. 9A to 9D are explanatory views illustrating an operational aspect of the lifting unit of the third modification. As shown in FIG. 9A, in the state (i.e., the opened state) where the cap 110 does not abut to the nozzle surface of the ejecting head 24, the substrate plate 121 is switched to the low position by the first cam shaft 152, and the box-type member 154 is also switched to low position by the second cam shaft 162. At this time, the cap 110 is pressed by the spring 122 installed to the substrate plate 121, and is weakly pressed to the hook portion 156.

From the above state, if the capping operation of the ejecting head 24 is performed, the box-type member 154 is changed to the high position by rotating the second cam shaft 162. Thereby, as shown in FIG. 9B, the cap 110 abuts to the nozzle surface. At this time, the cap 110, which is pressed to hook portion 156 until this time, is pressed to the nozzle surface and is lifted from the hook portion 156. As a result, the cap 110 can be pressed to the nozzle surface by the pressing force which is slightly stronger than the pressing force about the hook portion 156.

Also, when performing the suctioning of ink in the state (the opened state) shown in FIG. 9A, at first, the first cam shaft 152 is rotated and the substrate plate 121 is lifted. Thus, as shown in FIG. 9C, the cap 110 is pressed with strong force to the hook portion 156 by the spring 122 which is installed to the substrate plate 121. From the above state, if the second cam shaft 162 is again rotated and the box-type member 154 is lifted, the cap 110 is lifted in the state where the hook portion 156 is pressed with strong force. And, as shown in FIG. 9D, if the cap 110 abuts to the nozzle surface, the cap 110 is lifted from the hook portion 156, and as a result, the cap 110 is pressed to the nozzle surface with force which is further stronger than the pressing force about the hook portion 156 until this time.

If the lifting unit being installed in the maintenance mechanism 100, when performing the suction operation of ink, the cap 110 and the nozzle surface cannot contact with each other until immediately before the cap 110 abuts to the nozzle surface of the ejecting head 24. Therefore, comparing to the storage state of FIG. 8B shown above, the pressing force by which the cap 110 abuts to the nozzle surface can be more powerful, and deformation amounts caused by the abutting of the cap 110 about the nozzle surface can be substantially the same. As a result, the “collapse” of the cap 110 in the suction operation of ink can be suppressed effectively.

### C-4. Fourth Modification

In the embodiment, the first modification, the second modification, and the third modification as described above, it is explained that the lifting unit 120, which makes the pressing force of the cap 110 about the ejecting head 24 changeable, is applied to so-called the ink jet print 10 having a single head. However, the lifting unit 120 can be applied to an ink jet printer (so-called line printer) in which a plurality of ejecting heads 24 is disposed in parallel.

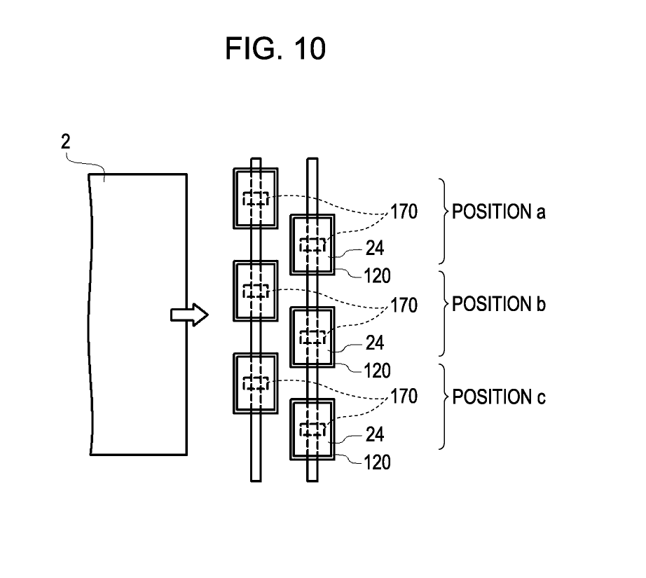

FIG. 10 is an explanatory view illustrating a lifting unit 120 of the fourth modification applied to the line printer. Also, FIG. 10 illustrates the aspect of a printing area of the line printer (ink jet printer 10) of the fourth modification when viewing from above thereof. As shown in FIG. 10, in the fourth modification of the line printer, six-ejecting heads 24, which are rectangular approximately in shape, are installed along with the direction orthogonal to the transporting direction of the printing medium 2. The six-ejecting heads 24 are arranged in 2 rows of 3 each, and the ejecting heads 24 of the one row are arranged to be different to each the ejecting heads of the other row. Also, the cap 110 (not shown in FIG. 10) abutting to the respective ejecting head 24 is installed downwards of the ejecting head 24, and the lifting unit 120 for lifting and lowering the cap 110 is installed downwards of the cap 110.

Further, in the lifting unit 120, a cam 170 for lifting and lowering the substrate plate 121 is installed as shown in FIG. 2A, and the cam 170 is fixed to the same shaft at every row in which the ejecting head 24 is installed. That is, three cams 170a, 170b, and 170c are installed at one shaft. In the lifting unit 120 of the fourth modification, shapes of cams 170a, 170b, and 170c mounted to the lifting unit 120 are a little different each other in three positions (position a, position b, position c) indicated in FIG. 10. Therefore, only the cap 110 disposed in the specific area can be strongly pressed to the nozzle surface of the ejecting head 24 as described below.

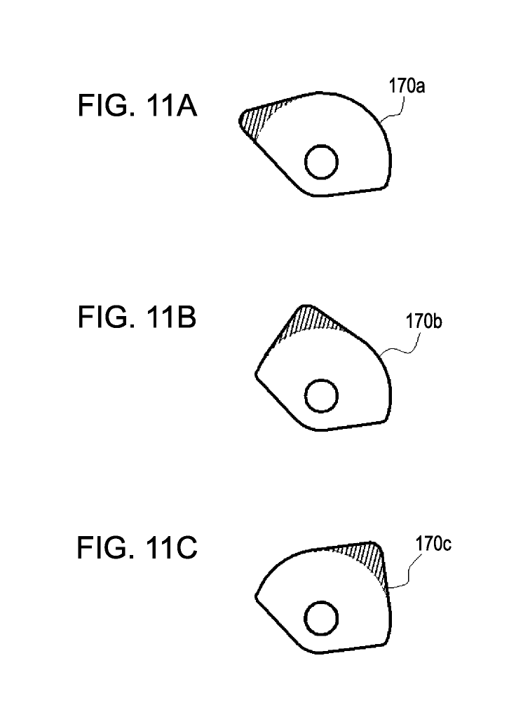

FIGS. 11A to 11C are explanatory views illustrating the shapes of cams 170a, 170b, and 170c mounted to the lifting unit 120 of the fourth modification. FIG. 11A illustrates the shape of the cam 170a which is installed on the lifting unit 120 of the “position a” of FIG. 10, FIG. 11B illustrates the shape of the cam 170b which is installed at the “position b”, and FIG. 11C illustrates the shape of the cam 170c which is installed at the “position c”. As shown in the above drawings, all cams 170a, 170b, and 170c, which are installed at respective positions, are formed to be an approximate fan-shape. A portion (a part which is indicated by a hatched line in the drawing) which is protruded from the one portion of the fan-shaped cams is formed, and the protruded portion is installed with a little displacement at the cams 170a, 170b, and 170c.

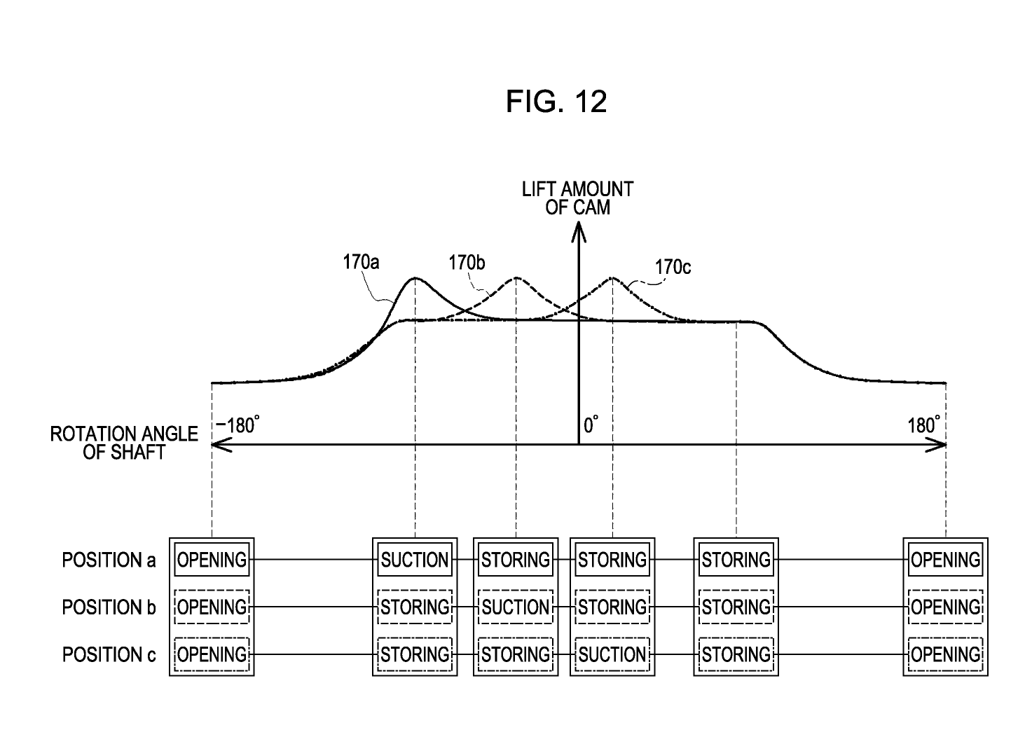

FIG. 12 is an explanatory view illustrating variations of a displacement (hereinafter, called a “lifting amount”) of the substrate plate 121 by the lifting of the cam 170a, 170b, and 170c about the substrate plate 121 of the lifting unit 120 when the lifting unit 120 of the fourth modification is operated. Also, FIG. 12 illustrates the aspect that the maintenance mechanism 100 of the cams 170a, 170b, and 170c is changed to any one of the opened state, the storage state, and the suctioning state according to variations of the lifting amount of the cams 170a, 170b, and 170c.

As described above with reference to FIG. 11, the approximate fan-shaped cams 170a, 170b, and 170c are formed in almost same configuration except the protruded portion indicated by hatched lines in the drawings. In a state where all the cams 170a, 170b, and 170c abut to the substrate plate 121 at a base circle (a part where a radius from a center of the cam is at its minimum), as illustrated in the left end of FIG. 12, the lifting amount of all the cams 170a, 170b, and 170c is at its minimum. At this time, all the maintenance mechanisms 100 are in the opened state.

From this state, when the shaft, at which three cams 170a, 170b, and 170c are installed, is rotated, the protruded portion (i.e., a part which the radius from the center of the cam 170 is at its maximum) of the cam 170a finally abuts to the substrate plate 121, at this time, the cam 170b and 170c abut to the substrate plate 121 at the fan-shaped portion (i.e., a part which the radius from the center of the cam 170 is at an intermediate size). Therefore, only the cap 110 of the maintenance mechanism 100 with the cam 170a installed is strongly pressed to the nozzle surface of the ejecting head 24, and is the suctioning state. However, the cap 110 of the maintenance mechanism 100 with cams 170b and 170c installed is weakly pressed to the nozzle surface, and is in the storage state.

Also, when cams 170a, 170b, and 170c are further rotated from the above state, the cam 170a abutting to the substrate plate 121 at the protruded portion abuts to the substrate plate 121 at the fan-shaped portion together with the cam 170c, and the cam 170b abuts to the substrate plate 121 at the protruded portion. Accordingly, only the maintenance mechanism 100 of the cam 170b is in the suctioning state, the maintenance mechanisms 100 of the cams 170a and 170c are in the storage state. Also, if the cams 170a, 170b, and 170c are rotated, the protruded portion of the cam 170c abuts to the substrate plate 121, and the fan-shaped portions of the cams 170a and 170b abut to the substrate plate 121, thus, only the maintenance mechanism 100 of the cam 170c is in the suctioning state, the maintenance mechanisms 100 of the cams 170a and 170b are in the storage state.

As described above, due to only the maintenance mechanism 100 of the cam 170c being in the suctioning state and the maintenance mechanisms 100 of the cams 170a and 170b being in the storage state, if the cams 170a, 170b, and 170c are further rotated, the fan-shaped portions of all the cams 170a, 170b, and 170c abut to the substrate plate 121. In the above state, all of the maintenance mechanisms 100 are in the storage state. Also, finally, due to all the cams 170a, 170b, and 170c abutting to the substrate plate 121 at the circular portion of the base, all of the maintenance mechanisms 100 are in the opened state again.

From the lifting unit 120 of the fourth modification described above, when the shaft to which the cams 170a, 170b, and 170c are installed is rotated, only the cap 110 of the maintenance mechanism 100 performing the suction operation of ink is strongly pressed to the nozzle surface of the ejecting head 24 and can suction the ink. Also, due to the cap 110 of the maintenance mechanism 100 not performing the suction operation of ink weakly abutting to the nozzle surface, the “collapse” of the cap 110 can be reduced.

Also, in the lifting unit 120 of the fourth modification, due to only the cap 110 performing the suction of ink being strongly pressed to the nozzle surface of the ejecting head 24, a load activating the ejecting head 24 can be suppressed, and rigidity for the ejecting head 24 does not need to be so high. As a result, by adopting the ejecting head 24 having the lower rigidity, weight saving of the ejecting head 24 can be realized.

While the ink jet printer 10 is described as the liquid ejecting apparatus of the embodiments above, this invention is not limited to the embodiments or modifications, and various aspects can be realized without departing from the scope of the invention. For example, while it is described in the above maintenance lifting unit provided in maintenance mechanism that the substrate plate is lifted and lowered by using any one of the cams, the lifting and lowering method of the substrate plate can be realized with any other means, for example, using the driving force of an electric motor, etc. without using the cams.

The entire disclosure of Japanese Patent Application No. 2010-003686, filed Jan. 12, 2010 is expressly incorporated by reference herein.

What is claimed is:

1. A liquid ejecting apparatus for ejecting a liquid using a liquid head provided with an ejecting nozzle, the liquid ejecting apparatus comprising:
a capping portion that forms a closed space around the ejecting nozzle by abutting to the ejecting head,
a negative pressure-introducing unit that introduces a negative pressure into the closed space in a state where the capping portion abuts to the ejecting head,
a capping portion-abutting unit that when the negative pressure is introduced into the closed space, the capping portion-abutting unit causes the capping portion to abut to the ejecting head with a greater pressing force than that in a case where the negative pressure is not introduced therein.

2. The liquid ejecting apparatus according to claim 1, wherein the capping portion includes:
a cap that forms the closed space between the cap and the ejecting head by abutting to the ejecting head,
an elastic member that applies an pressing force against the ejecting head to the cap when the cap abuts to the ejecting head, and
a cap holder that supports the cap through the elastic member,
wherein a positional relationship between the cap and the cap holder in a state where the cap abuts to the ejecting head is varied while causing the cap to abut to the ejecting head by driving the cap holder, and the capping portion-abutting unit changes the pressing force against the ejecting head.

3. The liquid ejecting apparatus according to claim 2, wherein the negative pressure-introducing unit includes:
a negative pressure pump that generates the negative pressure,
a negative pressure path that introduces the negative pressure generated by the negative pressure pump into the closed space; and
an opening/closing portion that opens and closes the negative pressure path,
wherein the capping portion-abutting unit opens the opening/closing portion according to an operation in which the positional relationship between the cap and the capping holder is varied so as to increase the pressing force.
